(19) United States
(12) Patent Application Publication
(10) Pub. No.: US 2026/0346311 A1
(43) Pub. Date: Nov. 5, 2026

(54) APPARATUS AND METHOD FOR SHREDDING AND RECYCLING ELECTRONIC DEVICES CONTAINING LITHIUM BATTERIES

(71) Applicant: Gloyd Recycling Solutions, LLC, Houston, TX (US)

(72) Inventors: Jeffrey David Gloyd, Houston, TX (US); Andrew James Spencer, Rutland, VT (US)

(73) Assignee: Gloyd Intellectual-Property Solutions, LLC, Houston, TX (US)

(21) Appl. No.: 19/554,210

(22) Filed: Mar. 2, 2026

Related U.S. Application Data
(60) Provisional application No. 63/766,243, filed on Mar. 3, 2025.

(51) Int. Cl. B09B 3/35; B01D 21/24; B01D 21/28; B01D 21/34; B01D 25/12; B01D 47/10; B01D 50/60; B01D 53/18; B02C 23/36; B03B 9/06; B09B 101/16; C02F 11/125; H01M 10/54

(52) U.S. Cl. CPC B09B 3/35; B01D 21/2438; B01D 21/2455; B01D 21/283; B01D 21/34; B01D 25/12; B01D 47/10; B01D 50/60; B01D 53/18; B02C 23/36; B03B 9/06; C02F 11/125; H01M 10/54; B03B 2009/066; B09B 2101/16

(57) ABSTRACT

An apparatus and method for shredding and recycling electronic devices containing lithium batteries is disclosed. The system uses a deluge shredder to comminute the electronic devices while suppressing thermal events. Shredded material is separated into black mass slurry and solid fragments using a vibratory pan, with black mass recovered using a filter press. Solid fragments undergo density-based separation in a sink-float tank to recover plastics and metals. An integrated emissions treatment system captures and scrubs vapors and particulates, maintaining a closed-loop process. The invention enables safe, efficient recycling of battery-containing electronic devices without prior battery removal.

### CROSS-REFERENCE TO RELATED APPLICATIONS

This application claims priority from U.S. Provisional Patent Application No. 63/766,243 filed on Mar. 3, 2025 which is hereby incorporated by reference herein.

### STATEMENT REGARDING FEDERALLY SPONSORED RESEARCH

Not Applicable.

### APPENDIX

Not Applicable.

### BACKGROUND OF THE INVENTION

### Field of the Invention

The present invention relates generally to systems and methods for mechanically processing electronic waste materials, and more particularly to systems and methods for safely shredding and separating electronic devices containing embedded lithium-ion batteries to recycle black mass material, ferrous metals, non-ferrous metals, and plastics.

### Related Art

Electronic waste (“e-scrap”) streams increasingly contain products with embedded lithium-ion batteries. Examples include laptops, tablets, mobile phones, cordless power tools, wireless speakers, robotic devices, and wearable electronics. These batteries are often inaccessible without extensive manual disassembly. Conventional recycling workflows rely on the labor-intensive removal of batteries prior to shredding due to the fire and emissions hazards associated with mechanical breakage of lithium-ion cells. When processed through traditional dry shredding systems, lithium-ion batteries can enter thermal runaway as a result of mechanical puncture, compression, or shear forces. Thermal runaway may initiate combustion, generate toxic fumes, and cause extensive facility damage or operator injury. Even small consumer cells can produce significant flame ejection and release highly reactive electrolyte vapors when compromised.

Existing mitigation systems for traditional dry shredding systems typically involve firefighting suppression equipment external to the shredder or environmental containment measures that react to, rather than prevent, hazardous conditions. None address the root problem: the inherent danger of combining batteries and dry shredding without a controlled quenching environment. Some prior art references propose discharging lithium batteries in a saline solution prior to shredding, such as U.S. Pat. No. 12,334,522, while other prior art references propose immersing the batteries during the shredding process, such as U.S. Pat. No. 11,273,453. More recently, the use of wet shredders have been incorporated into these systems, such as disclosed in US Pat. App. Pub. Nos. 2025/0038290 and 2025/0253425. However, these systems are designed for large-scale shredding and recycling operations which are particularly useful for electric vehicle lithium batteries and are not scaled for shredding and recycling of electronic devices that contain lithium batteries. Many recycling facilities receive mixed waste streams with electronic devices whose batteries cannot be easily removed prior to shredding, and these facilities require a system that allows for safe, economical shredding and recycling of the component in this e-scrap.

What is needed is an integrated mechanical and fluid-management system for shredding and recycling electronic devices that contain lithium batteries which eliminates the significant labor costs and safety risks associated with manual battery extraction. In particular, the waste management and recycling industry needs a scalable solution to safely and efficiently process electronic waste with devices that have embedded-batteries. Rather than constructing entirely new facilities for the electronic waste, it would be more efficient to use a turnkey system that is preassembled and can be transported in standard shipping containers so that they arrive in a condition that can be readied for operation without any additional construction required.

### SUMMARY OF THE INVENTION

An apparatus for shredding and recycling electronic devices containing lithium batteries includes a deluge shredder assembly, a vibratory pan assembly, a black mass tank, a filter press, a sink-float tank, a dewatering auger assembly, and a takeaway conveyor assembly. The deluge shredder assembly receives the electronic devices and comminutes the electronic devices with a flow of water into solid fragments and a black mass slurry with black mass material mixed with the water. The vibratory pan assembly is positioned below the deluge shredder assembly and receives the solid fragments and the black mass slurry; the vibratory pan assembly includes a perforated plate and a ledge at a distal end. The black mass tank is positioned below the vibratory pan assembly and receives the black mass slurry that passes through the perforated plate and settles at the bottom of the black mass tank. A pump pushes the black mass material and water from the black mass tank into the filter press to separate the black mass material from the water. The sink-float tank is positioned adjacent to the vibratory pan assembly and receives the solid fragments that fall off the vibratory pan assembly's ledge into the sink-float tank's saltwater bath that has a specific gravity that allows lighter plastic pieces in the solid fragments to float at the waterline and heavier pieces in the solid fragments to sink to the sink-float tank's bottom. The waterline is proximate to the crest of a weir, and the sink-float tank comprises at least one drive for moving the plastic pieces over the crest of the weir with a nappe of the saltwater and for extracting the heavier pieces from the bottom of the sink-float tank at the discharge end. The dewatering auger assembly is in fluid communication with the sink-float tank and receives in its lower end the lighter plastic pieces and the nappe of saltwater from the weir. The dewatering auger assembly removes the saltwater at the lower end and expels the plastic pieces at its upper end. The takeaway conveyor assembly is positioned adjacent to the sink-float tank. A takeaway tail at the takeaway conveyor assembly's proximal end is positioned below the sink-float tank's discharge end and receives the heavier pieces which are discharged from takeaway head at the takeaway conveyor assembly's a distal end.

In a particular aspect of the invention, the sink-float tank has an inclined ramp at its discharge end and a continuous loop drag chain assembly extending between the weir end and the inclined ramp. The drag chain assembly has a pair of chain-link loops on opposite sides of the sink-float tank, a plurality of paddles connected to and extending between the chain link loops, and a drive for rotating the drag chain assembly. The upper horizontal section of the chain-link loops is proximate to the waterline, and the horizontal section of the chain-link loops is proximate to the bottom of the sink-float tank. The paddles in the upper horizontal section push the lighter plastic pieces to the first end and over the crest of the weir with a nappe of the saltwater, and the paddles in the lower horizontal section push the heavier pieces along the bottom of the sink-float tank and up the inclined ramp to the drop-off chute.

In another aspect of the invention the components of the apparatus are mounted on a platform with a shipping configuration in which all of the components are within the platform's perimeter and fit within a standard 40-foot high-cube shipping container and with an operating configuration in which at least one of the components that discharge the separated solid fragments has an extended position that extends beyond the elongated platform's perimeter. In particular, the takeaway conveyor assembly has an extended position for the operating configuration and a retracted position for the shipping configuration of the apparatus. In its retracted position, the takeaway conveyor assembly is entirely situated within the perimeter of the elongated platform for the shipping configuration of the apparatus. In its extended position, the takeaway head extends beyond the elongated platform's perimeter for the operating configuration of the apparatus.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a front perspective view of the apparatus components assembled on a platform;

FIG. 1B is a back perspective view of the apparatus components assembled on a platform with a cutaway view of the deluge shredder assembly;

FIG. 2 is a schematic view of the components in the apparatus and their operations;

FIGS. 3A and 3B are a perspective view and a side view of the infeed hopper, respectively, with a detail view of the door the infeed hopper;

FIGS. 4A and 4B are a perspective view and a side view of the vibratory pan assembly, respectively;

FIG. 5 is a side view of the dewatering auger assembly;

FIG. 6A is a cutaway perspective view of the sink-float tank with the continuous loop drag chain assembly;

FIG. 6B is a top view of the sink-float tank;

FIG. 6C is a cross-sectional view of the sink-float tank taken along reference line 6C-6C with a detail view of the chain-link loops in the continuous loop drag chain assembly;

FIG. 6D is an enlarged fragmentary view of the paddles in the continuous loop drag chain assembly taken along reference line 6D-6D;

FIG. 7A is a cross-sectional side view of the takeaway conveyor assembly in its retracted position;

FIG. 7B is a side view of the takeaway conveyor assembly mounted on the platform in its extended position; and

FIG. 8 is a perspective view of a shipping container with a cutaway view showing the apparatus components assembled on a platform within the shipping container.

### DETAILED DESCRIPTION OF THE PREFERRED EMBODIMENTS

The following description of the preferred embodiment(s) is merely exemplary in nature and is in no way intended to limit the invention, its application, or uses.

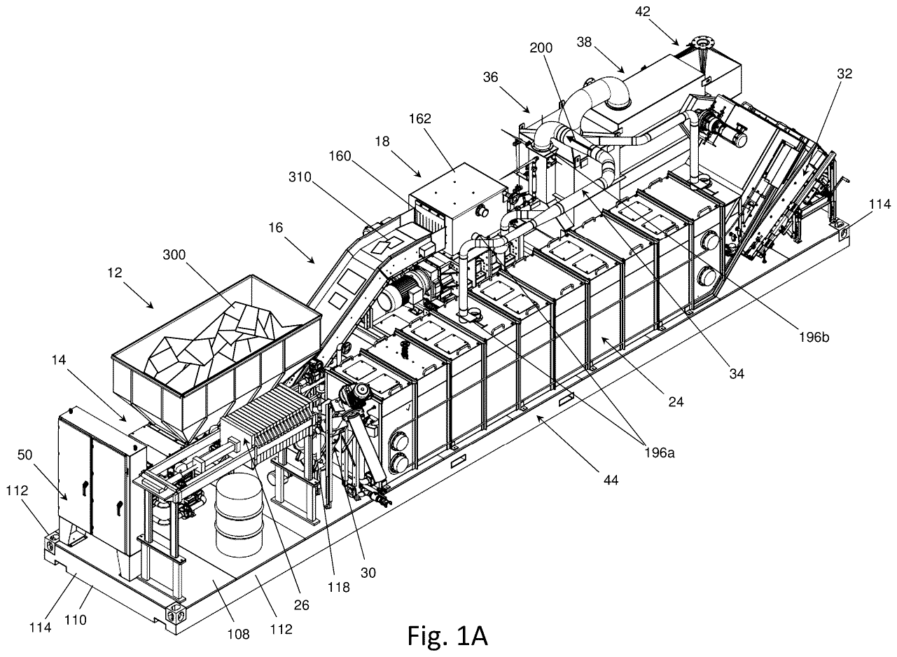

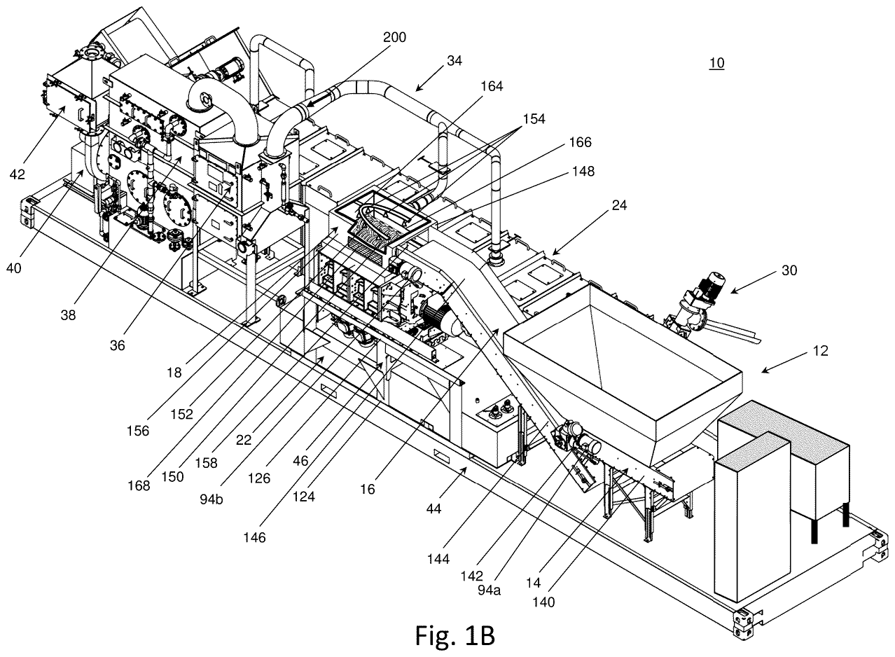

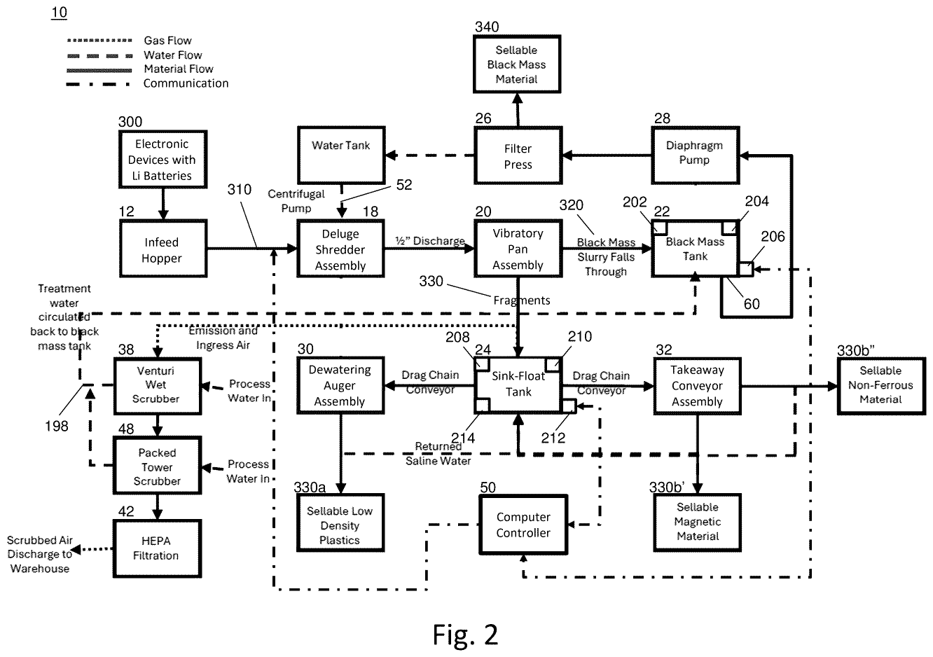

The present invention is an apparatus 10 and method for shredding and recycling a plurality of electronic devices containing lithium batteries 300 (e-scrap). The shredding and recycling apparatus is generally shown in FIGS. 1A and 1B, and a schematic view of the components in the apparatus and their operations is provided in FIG. 2. The apparatus has an infeed hopper 12 for the bulk loading of the e-scrap and which provides a regulated discharge of the e-scrap onto a lateral conveyor 14. The e-scrap is moved laterally under the infeed hopper and falls onto an inclined conveyor 16 which delivers the e-scrap into a deluge shredder assembly 18. Within the deluge shredder assembly, the e-scrap is continuously sprayed with a flow of water 52 to cool, suppress, and/or extinguish any thermal events produced by the lithium batteries as they are comminuted. The water flow preferably ranges between one (1) and fifty (50) gallons per minute to create a low-oxygen, high-moisture environment within the deluge shredder assembly. The deluge shredder assembly also preferably provides a sealed interface for the emissions system to maintain negative pressure.

A black mass slurry 320 and solid fragments 330 exit from the deluge shredder assembly fall onto a vibratory pan assembly 20 with a perforated plate 54. The black mass slurry and small particulates pass through the perforated plate into a black mass tank 22. The solid fragments remain on top of the perforated plate and are directed by shaking to the entrance of a sink-float tank 24. The black mass material and small particulates that settle at the bottom 60 of the black mass tank 22 are forced into a filter press 26 by a pump 28 to remove the black mass. The liquid removed from the black mass material 340 in the filter press is recirculated back to the deluge shredder assembly and the emissions treatment system. Temperature, level, and flow are monitored to maintain operational safety and stability.

For the solid fragments, the sink-float tank provides density-based separation of lighter plastic materials and heavier materials. In particular, the sink-float tank contains a saltwater bath 74 of controlled specific gravity to float the lighter plastic pieces 330a from the solid fragments and sink the heavier pieces 330b from the solid fragments. A continuous loop drag chain assembly 70 pushes the floating plastic pieces over a weir 62 to a dewatering auger assembly 30 and drags the sunken heavier pieces up an inclined ramp 66 above the saltwater bath's waterline 74a to a drop-off chute 80 where they are discharged onto a takeaway conveyor assembly 32.

The dewatering auger assembly 30 removes residual water from the plastic pieces at its lower end 96 and returns the water to the sink-float tank. The dewatered plastics are discharged from the dewatering auger assembly's upper end 98 for further processing or disposal. The takeaway conveyor assembly 32 preferably has a magnetic head conveyor 180 which separates ferrous material 330b′ from non-ferrous materials 330b″. The non-ferrous components fall off the magnetic head conveyor into a front chute 184 while the ferrous material remains held to the magnetic head conveyor past the front chute to a back chute 186 where they fall and are collected separately.

Emissions generated in the deluge shredder assembly and the sink-float tank are routed through exhaust ducts 34 to an emissions treatment system that includes a wet scrubber 36, a packed tower scrubber 38, a fan assembly 40, and a final high-efficiency particulate air (HEPA) filter 42. The system also uses closed-loop liquid recirculation to minimize the amount of water needed for the operations. The entire apparatus is preferably mounted on an elongated platform 44 that can be transported in standard shipping containers 400 so that it arrives in a condition that can be readied for operation without requiring any additional construction, preferably only changing the arrangement of the discharges for one or two components in the apparatus to transition from a shipping configuration to an operating configuration. As described in detail below, a shaker table frame 46 is mounted to the platform on opposite sides of the black mass tank, and the deluge shredder assembly and the vibratory pan assembly are mounted to the shaker table frame's top section. A computer controller 48 is preferably provided in an electrical cabinet 50 to help automate the operation of the apparatus and to also provide warnings and to shutdown the system when components in the system that are being monitored operate outside their acceptable threshold range.

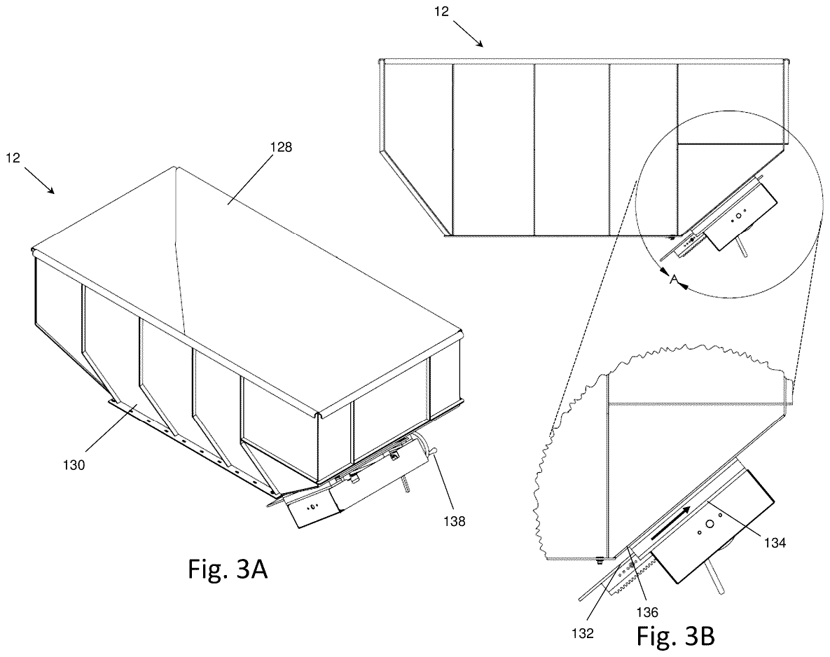

The infeed hopper that receives the electronic devices is preferably constructed from a structural steel, such as A36 carbon steel, and provides an approximate volumetric capacity of 94 cubic feet. This capacity is sufficient to supply thirty (30) to sixty (60) minutes of continuous shredder feed depending on the type of e-scrap material and the feed rate settings. As particularly shown in FIGS. 3A and 3B, the infeed hopper includes a tapered geometry consisting of a larger open topside 128 with a tapered lower section 130 that transitions into a discharge aperture 134 proximate to the bottom panel 136 of the tapered lower section. The upper section preferably measures approximately 42¾ inches in height, 50 inches in width, and 98½ inches in length. The tapered design promotes a consistent flow 310 of e-scrap and reduces bridging of bulky or irregularly shaped devices. A manually adjustable material flow door 132 is mounted at the lower discharge aperture. The door is moved using a hand-crank actuator 138 that allows operators to adjust the feed aperture to control the mass flow rate of e-scrap entering the lateral conveyor. In a restricted position, the door leaves open a smaller portion for a slower e-scrap flow rate, and in a fully open position, the opens the entire aperture for a faster e-scrap flow rate. This manual adjustment provides a simple and reliable means to regulate loading without the need for complex automated feed controls.

In operation, the e-scrap is dumped into the infeed hopper either by hand, forklift, or small front-loader, depending on the facility workflow. Once loaded, the e-scrap is drawn downward by gravity toward the controlled discharge door, where it is metered onto the moving belt of the lateral conveyor. The lateral conveyor's base is mounted directly to the elongated platform, and the infeed hopper assembly is preferably bolted directly onto a reinforced section of the conveyor's frame. Structural members and angled support brackets ensure that the infeed hopper's weight and dynamic loading are transferred uniformly to the conveyor base. This integrated mounting design improves system rigidity and alignment between the infeed hopper's outlet and the lateral conveyor's tail which receives the e-scrap from the infeed hopper.

The lateral tail 140 of the lateral conveyor's belt transports the e-scrap laterally to the lateral head 142 which is positioned above the inclined conveyor's lower tail. The lateral conveyor preferably uses a crescent-top PVC belt designed to improve material stability and reduce rollback during surges. The lateral conveyor is preferably powered by a single electric motor 94a that is controlled using a variable frequency drive (VFD) which allows belt speed adjustments from low-feed maintenance mode up to nearly twelve (12) feet per minute. The lateral conveyor provides a continuous and regulated feed of e-scrap to the inclined conveyor, and the adjustable VFD enables operators to match the feed rate to downstream conditions, preventing overloading of the deluge shredder assembly. The frame for the lateral conveyor is preferably constructed from welded steel components, including four adjustable-height legs that are bolted directly to the platform for vibration control and machine alignment. The dimensions for the lateral conveyor are approximately 43 inches tall, 27 inches wide, and 71 inches long. The frame preferably includes angled steel mounting plates specifically designed to align and secure the infeed hopper to ensure that the e-scrap exiting the infeed hopper falls directly onto the moving belt without spillage.

At the head of the lateral conveyor, the e-scrap falls onto the lower tail 144 of the inclined conveyor where it is transported to the upper head 146. The inclined conveyor elevates the e-scrap from the lateral conveyor into the deluge shredder assembly. The inclined conveyor has an incline of approximately thirty (30) degrees above horizontal to provide the necessary lift. The inclined conveyor uses a crescent-top PVC belt similar to the lateral conveyor but operates at a higher maximum speed of approximately nearly sixty (60) feet per minute. The one (1) HP motor 94b, operating at 1800 rpm and reduced through a 30:1 gearbox, provides the necessary torque, and the belt speed is controlled using a dedicated VFD. The inclined conveyor's frame is preferably fabricated from structural steel and includes four adjustable support legs with bolt-down plates. The physical dimensions of the conveyor frame are approximately 83½ inches tall, 20 inches wide, and a little over 142 inches long. A nose-over section at the upper head's discharge end ensures that material entering the deluge shredder assembly falls vertically downward into the shredder entry zone, preventing material from skipping or bouncing out of the shredder's hopper and enhancing safety by ensuring all feedstock passes through the deluge zone.

The deluge shredder assembly has a deluge hopper 148, a wet shredder 150, a spray bar 152, and multiple nozzles 154. The deluge hopper is preferably made from structural steel and is fastened through a mounting flange directly to the top of the wet shredder with bolts and an EPDM gasket. The deluge hopper has a closed top 162, an open bottom 164 to the wet shredder's cutting chamber 166, an opening 158 in one of its sidewalls 156, and an EPDM rubber curtain 160 with vertical slits is installed at the opening where the e-scrap from the inclined conveyor is deposited. The curtain reduces water splash-out and air ingress and aids in the maintenance of negative pressure inside the deluge shredder assembly. In general, the deluge shredder assembly performs three essential functions: (1) it provides a singular entry point for all incoming e-scrap materials; (2) it establishes a controlled deluge environment to quench thermal events while the e-scrap is comminuted; and (3) it forms the sealed interface through which emissions are extracted to the system's scrubbers.

The spray bar 152 is positioned proximate to the deluge hopper's closed top 162. The nozzles are fluidly connected to the spray bar and are aimed downward toward the open bottom 164 of the deluge hopper 148. The spray bar is preferably a two (2) inch stainless steel spray weldment which feeds six (6) spiral-pattern spray nozzles arranged to fully cover the cutting chamber. As indicated above, the spray system can deliver between one (1) and fifty (50) gallons per minute of water which can be varied based on operational conditions and fire suppression requirements. The nozzles spray the continuous flow of water onto the e-scrap upon entering the deluge hopper through the opening and while the electronic devices fall through the open bottom in the deluge hopper and are comminuted in the cutting chamber into the solid fragments and the black mass slurry which includes water, fine battery materials, graphite, electrolyte residue, and various micron-scale particulates. A four (4) inch diameter side-mounted exhaust duct 34 is connected at its upstream end 196a to one of the deluge hopper's sidewalls to allow the deluge hopper to interface with the emissions treatment system, enabling continuous extraction of vapors, smoke, and aerosolized particulates via the negative pressure.

During operation, all e-scrap materials entering the deluge shredder assembly fall through the deluge zone in the deluge hopper below the nozzles, ensuring they are wetted before contacting the shredder shafts in the cutting chamber. This wetting significantly reduces the likelihood of ignition, flame propagation, or thermal runaway events from embedded lithium-ion cells. In the preferred embodiment, the cutting chamber has a four-shaft industrial shredder configured for wet operation, such as the Untha® QS-40 (Generation 2.0) shredder which is equipped with two (2) thirty (30) HP electric motors, each driving paired cutter shafts through a reduction gearbox. The primary cutter shafts operate at approximately twenty-nine (29) rpm, while the secondary cutter shafts operate at approximately thirty-eight (38) rpm. The cutters include cast-iron nineteen (19) mm two (2) tooth designs on the primary shafts and case-hardened steel nineteen (19) mm four (4) tooth elements on the secondary shafts. This arrangement promotes efficient shearing of plastics, ferrous and non-ferrous metals, and lithium-ion cell casings.

A sizing screen 168, such as a Hardox® steel sizing screen, is mounted beneath the cutting chamber 166. The screen includes openings of approximately fifteen (15) mm which allows only the black mass slurry and solid fragments that have been sufficiently reduced in size to pass through onto the vibratory pan assembly below the deluge shredder assembly. Oversized pieces remain in the cutting chamber while they are further comminuted. The deluge shredder assembly includes built-in overload protection and automatic reverse cycling in the event that particularly dense materials become lodged between the cutters. In addition to reducing the available oxygen in the deluge hopper and wet shredder, the water introduced in the deluge zone cascades across the cutters and the screen, cooling the cutting environment. The constant deluge extinguishes flames associated with lithium-ion battery ruptures and suppresses the emission of hazardous vapors.

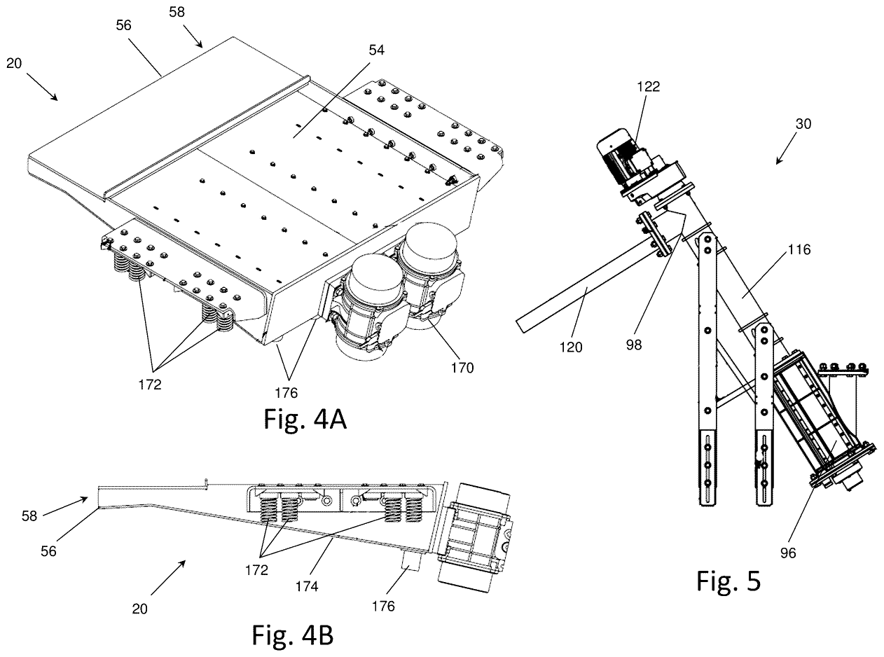

Details of the vibratory pan assembly are described below with reference to FIGS. 4A and 4b. The perforated plate 54 in the vibratory pan assembly 20 is constructed from stainless steel and features a screening surface with small diameter perforations, such as 3/32-inch diameter perforations. Two (2) vibratory motors 170, such as Powtek VE3/18/1500 industrial vibrators, are mounted to the vibratory pan assembly and preferably operate in coordinated counter-rotation to provide linear vibration that drive the solid fragments across the perforated plate toward a distal edge of the vibratory pan assembly. Each motor is driven by a variable frequency drive (VFD), allowing operators to adjust vibratory amplitude and frequency for optimal material transport and liquid separation. The vibratory pan assembly is supported by twelve (12) stainless steel springs 172 arranged around its perimeter. These springs provide vibration isolation and maintain consistent oscillatory motion during operation.

The vibratory pan assembly 20 also includes a welded stainless steel collection tray 174 positioned beneath the perforated plate. The collection tray is slanted downward away from the distal edge, and several ports 176 are attached to the bottom of the collection tray at its lowest region. As the black mass slurry from the lithium-ion batteries and solid fragments fall onto the vibratory pan assembly, the black mass with water and small particulates pass downward through the perforated plate into the steel collection tray and continue down the slanted bottom surface to the ports. The ports are connected to the black mass tank through pipes which channel the black mass slurry and small particulates to the black mass tank. The solid fragments that are not small enough to fit through the perforations remain on the top of the perforated plate and are conveyed forward by the vibratory motion toward the distal edge. The physical dimensions of the vibratory pan assembly are approximately 17¾ inches tall, 53¾ inches wide, and 63¾ inches long, enabling it to span the full width of the shredder discharge area.

The black mass tank 22 is preferably a welded stainless steel vessel with a nominal capacity of approximately 360 gallons that is positioned directly beneath the vibratory pan assembly to receive the black mass slurry through the pipes connected to the ports in the vibratory pan assembly's collection tray. The black mass tank's physical dimensions are 20¾ inches tall, 38 inches wide, and 144 inches long, allowing it to fit neatly within the footprint of the shaker table frame. The black mass slurry enters the black mass tank through the ports located beneath the vibratory pan. The black mass tank preferably incorporates a sloped bottom to encourage particulate settlement at its lowest end, and the pump 28 feeding the filter press 26 is preferably a diaphragm pump.

The diaphragm pump 28 removes black mass slurry from the black mass tank and passes it through a 34-plate filter press equipped with 2-3 micron filtration media, such as the Met-Chem® MC-10-630-34 filter press. As solids accumulate, internal filter pressure increases from 30 psi up to approximately 90 psi. When 90 psi is reached, a signal is sent to the system's computer controller to pause the lateral conveyor and the inclined conveyor until the filter press is serviced. A separate centrifugal pump preferably withdraws clarified liquid from the black mass tank and supplies water to the deluge shredder assembly's spray bar and to the wet scrubber in the emissions treatment system. Water used in the emissions treatment system drains back into the black mass tank, enabling closed-loop recirculation.

The black mass tank preferably includes instrumentation in communication with the computer controller for monitoring and controlling operations of the system: one (1) temperature sensor 202, one (1) continuous level sensor 204, and two (2) discrete level switches 206. When the temperature sensor reads a temperature in the black mass tank that reaches an elevated temperature threshold, such as 65 °C, the computer controller provides a warning. If the temperature reaches a highly elevated temperature threshold, such as 85 °C, the computer controller automatically shuts down the system. Level sensors initiate automatic makeup water flow when volume drops below approximately 140 gallons and prevent overflow when volume exceeds approximately 360 gallons. The black mass tank also includes several removable access panels secured by bolts to facilitate maintenance, slurry removal, and cleaning. Additionally, two (2) ¾-inch breather vents ensure that the internal tank pressure remains at atmospheric levels during operation.

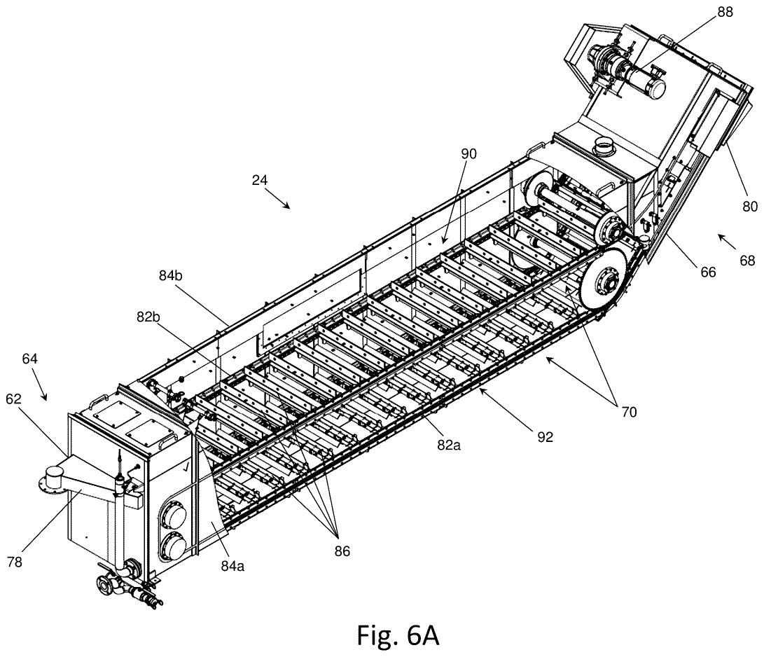

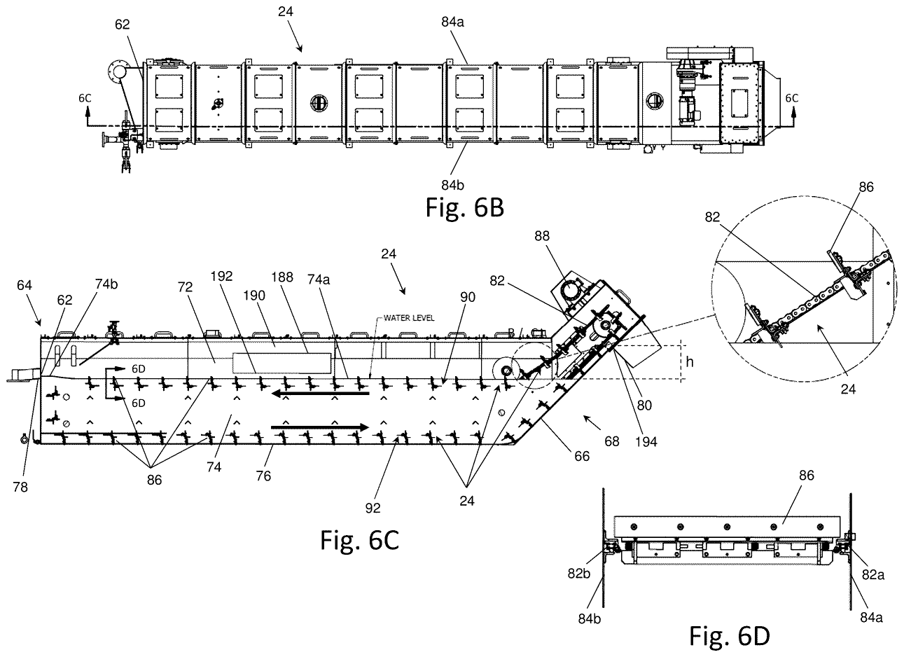

The sink-float tank 24 is positioned adjacent to the vibratory pan assembly and is filled with saltwater maintained at a controlled specific gravity between 1.08 and 1.22. Details of the sink-float tank are described below with reference to FIGS. 6A-6D. A ledge 56 at the distal end 58 of the vibratory pan assembly 20 extends into an interior 72 of the sink-float tank through a slot 188 in the sidewall 190 of the sink-float tank where the solid fragments drop into the saltwater solution. The tank is preferably constructed from stainless steel and has an approximate capacity of 1300 gallons. The saltwater density range enables the lighter plastic pieces to float at the waterline while permitting the heavier pieces to sink to the bottom 76 of the sink-float tank, such as metal fragments and circuit board fragments.

Within the sink-float tank 24, the continuous loop drag chain assembly 70 is formed by a pair of stainless steel chain-link loops 82a, 82b on opposite sides 84a, 84b of the sink-float tank with ultra-high-molecular-weight (UHMW) polyethylene paddles 86 connected to and extending between the chain link loops 82. The drag chain assembly extends in a continuous loop between the weir 62 at the end 64 of the sink-float tank which is adjacent to the dewatering auger assembly 30 and the inclined ramp 66 at the discharge end 68 of the sink-float tank which is adjacent to the takeaway conveyor assembly 32 and opposite from the weir end. A drive 88 rotates the chain-link loops 82 with an upper horizontal section 90 of the chain-link loops being proximate to the waterline and a lower horizontal section 92 of the chain-link loops being proximate to the bottom 76 of the sink-float tank. The paddles in the upper horizontal section push the floating lighter plastic pieces toward the dewatering auger end of the sink-float tank and over the crest 78 of the weir 62 with a nappe 74b of the saltwater, and the paddles in the lower horizontal section simultaneously push the sunken heavier pieces along the bottom of the sink-float tank and up the inclined ramp 66 to the drop-off chute 80. To function efficiently, the waterline is proximate to a crest of the weir, and the drop-off chute is positioned at a height (h) above the waterline; preferably, the interface 194 between the inclined ramp and the drop-off chute is above a bottom edge 192 of the slot 188 to ensure sufficient drainage of the saltwater before the heavier pieces are discharged onto the takeaway conveyor assembly. The drag chain assembly's drive includes a 1.5 HP electric motor operating at approximately 1475 rpm which drives a 649:1 ratio gearbox, producing a chain travel speed adjustable between 2.5 and 8.5 feet per minute via VFD control. The maximum chain speed is approximately 9.4 feet per minute.

The sink-float tank is enclosed with multiple removable maintenance panels that allow for inspection of the drag chain assembly as well as cleaning of the sink-float tank's interior and removal of debris. The physical dimensions of the tank are approximately 86 7/32 inches tall, 52⅜ inches wide, and 316 9/16 inches long. Two (2) four (4) inch emissions flanges are located on the sink-float tank's cover, enabling connection of the upstream end 196a of the exhaust ducts 36. The flanges maintain negative pressure during operation, capturing vapors and aerosolized particulates released from comminuted e-scrap fragments and drawing them to the emissions treatment system.

Similar to the black mass tank, the sink-float tank also incorporates instrumentation in communication with the computer controller for monitoring and controlling operations of the system: one (1) temperature sensor 208, one (1) continuous level sensor 210, two (2) discrete level switches 212, and one (1) conductivity meter 214. The conductivity meter is used to maintain appropriate salinity levels by adding fresh or saltwater when the specific gravity drifts outside the controlled threshold range which is preferably between 1.08 and 1.22. If the liquid levels exceed 1300 gallons or drop below 1100 gallons, the computer controller automatically shuts down the system. At the maximum level, the waterline remains below the bottom edge of the slot. The temperature thresholds and controls are similar to those for the black mass tank and result in a warning at 65 °C and a shutdown at 85 °C.

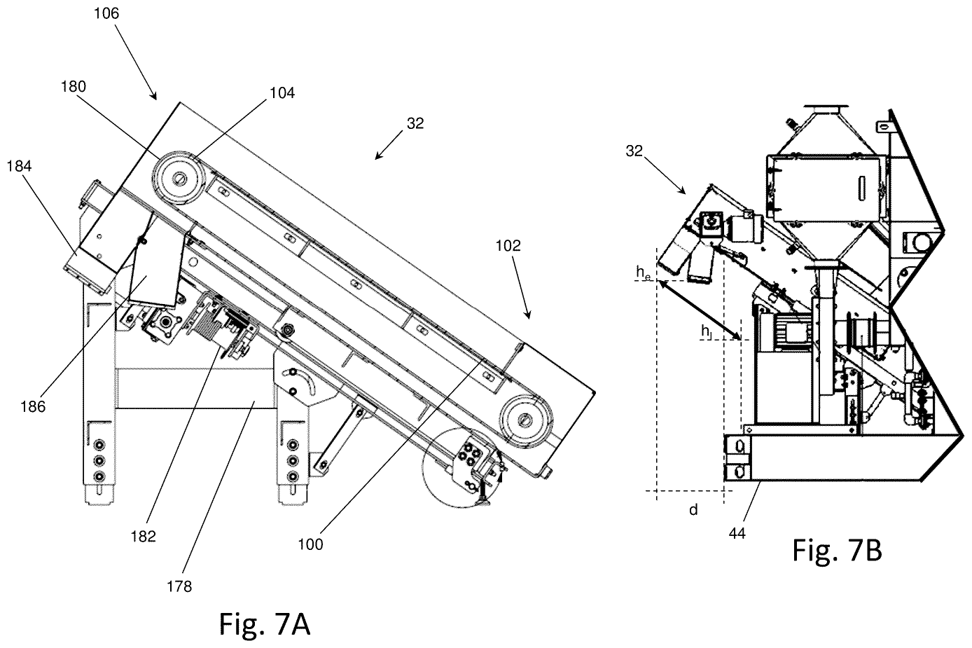

As shown in FIGS. 7A and 7B, the takeaway conveyor assembly 32 has a takeaway tail 100 at its proximal end 102 and a takeaway head 104 at its distal end 106. During operations of the apparatus, the takeaway tail is positioned below the drop-off chute and receives the heavier pieces, and the heavier pieces are discharged from the takeaway head. In addition to the magnetic head conveyor 180, the takeaway conveyor assembly includes a conveyor frame 178, an actuator 182, a front chute 184, and a back chute 186. The actuator moves the magnetic head conveyor on the conveyor frame between a retracted position for shipping and an extended position for use during operations of the apparatus. The non-magnetic materials in the heavier pieces fall from the takeaway head into the front chute, and the magnetic materials in the heavier pieces are held by the iron-boron permanent magnet in the takeaway head past the front chute and then fall from the takeaway head into the back chute.

The takeaway conveyor assembly 32 uses a crescent-top PVC belt powered by a one (1) HP motor running at 1800 rpm through an 80:1 gearbox. Belt speed is VFD-controlled, with a maximum conveyance rate of approximately 31 feet per minute. The conveyor frame is fabricated from structural steel and mounted on four adjustable legs with bolt-down plates that are directly fastened to the platform. The actuator can be a manually operated winch-and-cable adjustment mechanism or it can be powered. The magnetic head conveyor is angled on the conveyor frame at approximately 30 degrees. The actuator raises the discharge height to an elevated height (hₑ) when the magnetic head conveyor is in its extended position and lowers the discharge height to a lowered height (hₗ) when the magnetic head conveyor is in its retracted position. The physical dimensions of the conveyor and stand are approximately 51 inches tall, 27 inches wide, and 67 5/32 inches long. As particularly shown in FIG. 7B, in the extended position of the takeaway conveyor assembly, its distal end is positioned a distance (d) beyond the platform's perimeter so that both the front chute and the back chute are outside the perimeter and can empty into containers positioned on the floor adjacent to the platform.

The dewatering auger assembly 30, shown in FIG. 5, includes a sump pump 118 at its lower end 96, a discharge chute 120 proximate to the upper end 98, and an inclined auger 116 extending between the sump pump and the discharge chute. The inclined auger is constructed of stainless steel with a dewatering chamber at the lower end and a long tubular housing extending upward to the discharge chute at a 58-degree incline. The lighter plastics that were pushed over the crest of the weir with the nappe of the saltwater are funneled down to the lower end of the inclined auger. The dewatering chamber contains a perforated internal screen through which the saltwater drains and is collected by a 1½-inch centrifugal sump pump. The sump pump returns the drained saltwater back into the sink-float tank. A four (4) HP electric motor 122 drives the auger through a 16.53:1 reduction gearbox. The auger operates at adjustable speeds controlled via a VFD, with a maximum rotational speed of approximately 88 rpm. The dewatered lighter plastics are conveyed upward through the inclined tube and deposited through the discharge chute into collection bins, gaylords, or downstream processing equipment. The dewatering auger assembly preferably includes adjustable support legs for direct mounting to the platform and a flanged connection to the sink-float tank's weir.

The apparatus preferably includes a multistage emissions treatment assembly that is preferably designed to process up to approximately 1000 actual cubic feet per minute (acfm) of air extracted from the deluge shredder assembly 18 and the sink-float tank 24 through the exhaust ducts 34. The emissions system begins with the wet scrubber 36 at the downstream end 196b of the exhaust ducts. The wet scrubber is preferably a dual-throat scrubber which injects between four (4) and ten (10) gallons per minute of recirculated water supplied from the black mass tank 22 into a high-velocity airflow 200 path to capture smoke, aerosolized battery electrolyte vapors, and fine particulate matter. Entrained solids and condensate drain downward and return to the black mass tank through a drain tube 198.

Vapor exiting the wet scrubber flows into the packed tower scrubber 38 which includes two stages of polypropylene packing media. The first stage is approximately four (4) feet high and the second stage is approximately two and a half (2.5) feet high. A dedicated 1½ HP pump circulates water through the tower, achieving approximately 99% removal of particulates that are ten (10) microns or larger and significant reducing acid gases and volatile organic compounds.

Downstream of the scrubbers, the air stream is drawn through a 7.5 HP centrifugal exhaust fan 40. The fan maintains the negative pressure required for continuous emissions capture at the exhaust duct interfaces with the deluge shredder assembly and the sink-float tank. Airflow is regulated to ensure a maximum draw of approximately 1000 acfm. The final stage of the emissions system is the HEPA filter 42 which captures ultrafine particulates, including trace black mass dust, while the carbon filter removes residual VOCs and electrolyte vapors. All liquids and condensates from the scrubbers are routed back to the black mass tank, maintaining liquid recirculation within a closed-loop operation.

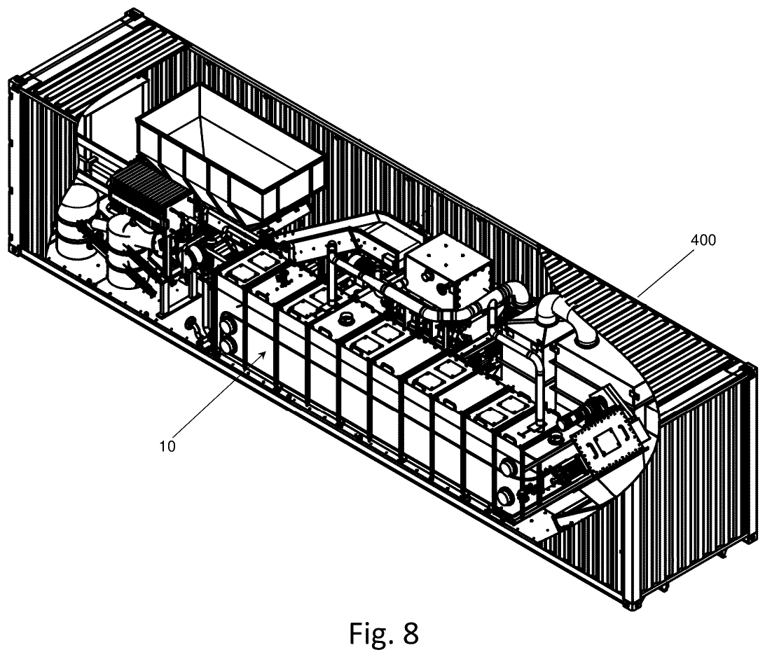

As generally described above, the entire apparatus is preferably mounted on the top surface 108 of the elongated platform 44 with longitudinal sides 112 and transverse sides 114 therebetween that are sized to be transported in standard shipping containers 400, such as shown in FIG. 8. The platform is fabricated as a rigid, welded steel frame with an overall length of approximately 467.5″, a width of approximately 91″, and a vertical height of 13″, measured from the platform's bottom surface 110 to the top mounting surface 108. The platform preferably includes bolt-down mounting points for anchoring the system to a concrete foundation. Accordingly, the platform functions as both a structural base and a transportation skid, enabling the system's components to be fully assembled off-site and transported as a single integrated unit. When assembled, the platform and attached apparatus are sized and arranged to slide into a standard 40-foot high-cube shipping container, enabling containerized transport by road, rail, or sea without partial disassembly

The platform includes reinforced beams, cross-members, and localized load-bearing regions aligned with major equipment components of the system's apparatus. Integrated lifting pockets and attachment points allow the platform to be lifted using forklifts, cranes, or container-handling equipment. Mounting features mechanically secure the components to the platform, reducing vibration, shifting, and mechanical stress during transport. In use, the platform remains in place during installation, allowing the system to be deployed rapidly by positioning the platform within a facility and connecting utilities, thereby reducing installation time and minimizing on-site mechanical assembly. The system preferably includes an electrical and computer control cabinet that is mounted to one end of the platform.

For the shipment of the apparatus, all of the components are positioned within the platform's perimeter in a shipping configuration, i.e., within the longitudinal sides and the transverse sides. When the apparatus is readied for operation and during operations, one or more of the components are moved into an operating configuration for the apparatus in which the components extend beyond the perimeter. Preferably, the components that discharge the output materials from the system are the ones which are moved so that the output materials fall into collection bins, gaylords, or downstream processing equipment. For example, the takeaway conveyor assembly and the dewatering auger assembly are both entirely within the platform's perimeter in the shipping configuration and have discharge ends that extend beyond the platform's perimeter in the operating configuration.

For the shipping configuration, the takeaway conveyor assembly has a retracted position in which it is situated entirely within the perimeter of the elongated platform. For the operating configuration, the takeaway conveyor assembly has an extended position in which the takeaway head extends beyond the platform's perimeter. The conveyor frame is fixed entirely within the perimeter, and as explained above, the actuator moves the magnetic head conveyor on the conveyor frame between its retracted position and extended position. Similarly, the dewatering auger assembly's discharge chute can be situated entirely within the platform's perimeter in the apparatus' shipping configuration and can extend beyond the platform's perimeter in the apparatus' operating configuration.

Most of the system's components are mounted directly to the elongated platform 44, but some components are mounted to the shaker table frame 46 to isolate vibratory loads and prevent unwanted oscillation transfer into adjacent components. The lateral conveyor 14, the black mass tank 22, the sink-float tank 24, the dewatering auger assembly 30, the takeaway conveyor assembly 32, and the modules that form the emissions treatment assembly are mounted directly to the elongated platform separate from the shaker table. The bottom section 124 of the shaker table frame is mounted to the platform on opposite sides of the black mass tank, and its top section 126 extends above and over the black mass tank. The deluge shredder assembly 18 and the vibratory pan assembly 20 are mounted to the top section of the shaker table frame. For the inclined conveyor 16, its lower tail 144 is preferably mounted directly to the elongated platform 44 while its upper head 146 is mounted to the top section of the shaker table frame 126.

The shaker table frame is constructed from welded stainless steel tubing and plate sections, and its dimensions are approximately 46 5/16 inches tall, 48¼ inches wide, and 124½ inches long. Structural stiffness is maintained through cross-bracing integrated into the tubular parts. As indicated above, the shaker table frame's open central portion is sized to accommodate the black mass tank. The upper section provides mounting rails for the vibratory pan and the shredder support structure, ensuring a consistent discharge trajectory from the shredder to the vibratory pan. The upper section includes mounting provisions for the inclined conveyor to ensure precise vertical alignment between the conveyor discharge nose and the deluge hopper's opening.

By enabling safe, immediate shredding of intact battery-containing devices without prior battery removal, the apparatus of the present invention significantly reduces labor requirements, improves processing throughput, and minimizes the risk of fire, explosion, and toxic emissions. The system maintains a closed-loop liquid and emissions management process while safely and efficiently separating shredded e-scrap into recoverable outputs, including black mass slurry, plastic pieces, ferrous metals, and non-ferrous metals. The system provides recycling facilities with a system that allows for safe, economical shredding and recycling of the component in this e-scrap. The modular and compact design of the system permits preassembled units to be transported in standard shipping containers, enabling mobile deployment to disaster response zones, remote industrial sites, contract recycling operations, and facilities with limited floor space. The system is applicable to a wide range of industrial, municipal, and commercial recycling environments where end-of-life electronics containing embedded lithium-ion batteries must be processed safely and efficiently. Municipal waste handling sites, transfer stations, and household hazardous waste programs can deploy the system to mitigate fire hazards arising from lithium-ion batteries frequently found in consumer electronics discarded in mixed-waste bins.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An apparatus for shredding and recycling a plurality of electronic devices containing lithium batteries, comprising:
a deluge shredder assembly, wherein the deluge shredder assembly receives a flow of the electronic devices and comminutes the electronic devices with a continuous flow of water into solid fragments and a black mass slurry with black mass material mixed with the water;
a vibratory pan assembly positioned below the deluge shredder assembly, wherein the vibratory pan assembly receives the solid fragments and the black mass slurry, and wherein the vibratory pan assembly is comprised of a perforated plate and a ledge at a distal end;
a black mass tank positioned below the vibratory pan assembly, wherein the black mass slurry passes through the perforated plate into the black mass tank, and wherein the black mass material settles at a bottom of the black mass tank;
a pump operatively connected to the bottom of the black mass tank;
a filter press, wherein the pump pushes the black mass material and water from the bottom of the black mass tank through the filter press, and wherein the filter press separates the black mass material from the water;
a sink-float tank positioned adjacent to the vibratory pan assembly, wherein the sink-float tank comprises a weir at a first end, an inclined ramp at a second end opposite from the first end, and a continuous loop drag chain assembly extending between the first end and the second end, wherein the ledge at the distal end of the vibratory pan assembly extends into an interior of the sink-float tank, wherein the solid fragments pass from the distal end of the vibratory pan assembly into the sink-float tank, wherein the sink-float tank contains saltwater with a specific gravity allowing lighter plastic pieces in the solid fragments to float at a waterline for the saltwater and heavier pieces in the solid fragments to sink to a bottom of the sink-float tank, wherein the waterline is proximate to a crest of the weir, wherein the inclined ramp extends from the bottom of the sink-float tank to a drop-off chute positioned at a height above the waterline, wherein the continuous loop drag chain assembly is comprised of a pair of chain-link loops on opposite sides of the sink-float tank, a plurality of paddles connected to and extending between the chain link loops, and a drive for rotating the drag chain assembly, wherein an upper horizontal section of the chain-link loops is proximate to the waterline, wherein a lower horizontal section of the chain-link loops is proximate to the bottom of the sink-float tank, wherein the paddles in the upper horizontal section push the lighter plastic pieces to the first end and over the crest of the weir with a nappe of the saltwater, and wherein the paddles in the lower horizontal section push the heavier pieces along the bottom of the sink-float tank and up the inclined ramp to the drop-off chute;
a dewatering auger assembly in fluid communication with the sink-float tank, wherein the dewatering auger assembly receives in a lower end the lighter plastic pieces and the nappe of saltwater from the weir, and wherein the dewatering auger assembly removes the saltwater at the lower end and expels the lighter plastic pieces at an upper end; and
a takeaway conveyor assembly positioned adjacent to the sink-float tank, wherein a takeaway tail at a proximal end of the takeaway conveyor assembly is positioned below the drop-off chute and receives the heavier pieces, and wherein the heavier pieces are discharged from a takeaway head at a distal end of the takeaway conveyor assembly.

2. The apparatus of claim 1, further comprising an elongated platform comprising a top surface, a bottom surface, a pair of longitudinal sides, and a pair of transverse sides extending between the longitudinal sides, wherein the pair of longitudinal sides and the pair of transverse sides define a perimeter of the elongated platform, wherein the takeaway conveyor assembly has an extended position for an operating configuration of the apparatus, wherein the takeaway conveyor assembly has a retracted position for a shipping configuration of the apparatus, wherein the takeaway conveyor assembly is situated entirely within the perimeter of the elongated platform in the retracted position, and wherein the takeaway head extends beyond the perimeter of the elongated platform in the extended position.

3. The apparatus of claim 2, wherein the dewatering auger assembly is comprised of a sump pump at the lower end, a discharge chute proximate to the upper end, and an inclined auger extending between the sump pump and the discharge chute, wherein the discharge chute extends beyond the perimeter of the elongated platform in the operating configuration of the apparatus, and wherein the discharge chute is situated entirely within the perimeter of the of the elongated platform in the shipping configuration of the apparatus.

4. The apparatus of claim 2, further comprising a shaker table frame with a bottom section mounted to the elongated platform on opposite sides of the black mass tank and a top section extending above and over the black mass tank, wherein the deluge shredder assembly and the vibratory pan assembly are mounted to the top section of the shaker table frame, wherein the black mass tank is mounted directly to the elongated platform within the bottom section of the shaker table frame, and wherein the sink-float tank, the dewatering auger assembly, and the takeaway conveyor assembly are mounted directly to the elongated platform separate from the shaker table.

5. The apparatus of claim 4, further comprising:
an infeed hopper for receiving the electronic devices, wherein the infeed hopper comprises an open topside, a tapered lower section, a door positioned in an aperture proximate to a bottom panel of the tapered lower section, and an actuator operatively connected to the door, wherein the actuator adjusts door between a first position within the aperture and a second position within the aperture, wherein the first position opens a first portion of the aperture and has a first flow rate of the electronic devices, wherein the second position opens a second portion of the aperture and has a second flow rate of the electronic devices, and wherein the second portion of the aperture and the second flow rate are greater than first portion of the aperture and the first flow rate, respectively;
a lateral conveyor positioned below the aperture of the infeed hopper, wherein the lateral conveyor receives the flow of the electronic devices from the infeed hopper at a lateral tail and discharges the electronic devices at a lateral head; and
an inclined conveyor extending from a lower tail to an upper head, wherein the lower tail is positioned below the lateral head and is mounted directly to the elongated platform, and wherein the upper head reaches the deluge shredder assembly and is mounted to the top section of the shaker table frame.

6. The apparatus of claim 4, wherein the deluge shredder assembly is further comprised of a deluge hopper, a wet shredder, a spray bar, and multiple nozzles, wherein the deluge hopper is comprised of a plurality of sidewalls, an opening in one of the sidewalls, a curtain in the opening, a closed top, and an open bottom, wherein the spray bar is positioned proximate to the closed top of the deluge hopper, wherein the nozzles are fluidly connected to the spray bar and are aimed downward toward the open bottom, wherein the wet shredder is comprised of a cutting chamber above a screen, wherein the wet shredder is attached to the sidewalls of the deluge hopper spaced directly below the open bottom, wherein the nozzles spray the continuous flow of water onto the electronic devices upon entering into the deluge hopper through the opening and while the electronic devices fall through the open bottom in the deluge hopper and are comminuted in the cutting chamber into the solid fragments and the black mass slurry that pass through the screen to the vibratory pan assembly, wherein the vibratory pan assembly is further comprised of a vibratory motor, a plurality of springs, a collection tray, and a plurality of ports, wherein the springs connect the vibratory pan assembly to the shaker table, wherein the collection tray is positioned below the perforated plate and is slanted downwards toward the ports, and wherein the ports are attached to the collection tray and channel the black mass slurry into the black mass tank.

7. The apparatus of claim 1, wherein the takeaway conveyor assembly is further comprised of a conveyor frame, a magnetic head conveyor, an actuator, a front chute, and a back chute, wherein the actuator moves the magnetic head conveyor on the conveyor frame between the retracted position and the extended position, wherein non-magnetic materials in the heavier pieces fall from the takeaway head into the front chute, and wherein the magnetic materials in the heavier pieces are held by the takeaway head past the front chute and fall from the takeaway head into the back chute.

8. The apparatus of claim 1, wherein the sink-float tank comprises a slot in a sidewall, wherein the distal end of the vibratory pan assembly extends through the slot into the interior of the sink-float tank, wherein the waterline is below a bottom edge of the slot, wherein an interface between the inclined ramp and the drop-off chute is above the bottom edge of the slot.

9. The apparatus of claim 1, further comprising:
a plurality of exhaust ducts connected at an upstream end to the deluge shredder assembly and the sink-float tank;
a wet scrubber, wherein a downstream end of the exhaust ducts is connected to the wet scrubber, wherein a drain tube connects the wet scrubber with the black mass tank, wherein the wet scrubber removes entrained solids and condensate from an airflow received through the exhaust ducts, wherein the entrained solids and condensate flow through the drain tube from the wet scrubber to the black mass tank;
a packed tower scrubber operatively connected to the wet scrubber, wherein the airflow exiting the wet scrubber enters the packed tower scrubber;
an exhaust fan downstream of the wet scrubber and the packed tower scrubber, wherein the exhaust fan draws the airflow through the wet scrubber and the packed tower scrubber; and
a high-efficiency particulate air filter operatively connected to the packed tower scrubber and the exhaust fan.

10. The apparatus of claim 9, further comprising a computer controller, wherein the black mass tank is further comprised of a first temperature sensor, a first water level sensor, and a first water level switch in operative communication with the computer controller, wherein the first temperature sensor produces a first temperature reading of the black mass slurry in the black mass tank, wherein the computer controller produces a first warning signal if the first temperature reading exceeds a first temperature threshold, wherein the computer controller causes the apparatus to stop operating if the first temperature reading exceeds a second temperature threshold greater than the first temperature threshold, wherein the first water level sensor produces a first level reading of the black mass slurry in the black mass tank, wherein the computer controller causes the first water level switch to increase the black mass slurry level in the black mass tank when the level reading is below a first threshold level, wherein the sink-float tank is further comprised of a second temperature sensor, a second water level sensor, a second water level switch, and a conductivity meter, wherein the second temperature sensor produces a second temperature reading of the saltwater in the sink-float tank, wherein the computer controller produces a first warning signal if the second temperature reading exceeds the first temperature threshold, wherein the computer controller causes the apparatus to stop operating if the second temperature reading exceeds the second temperature threshold greater than the first temperature threshold, wherein the second water level sensor produces a second level reading of the saltwater in the sink-float tank, wherein the conductivity meter produces an electrical conductivity reading for the salt water, wherein the computer controller causes the second water level switch to produce at least one of a freshwater flow and a saltwater flow into the sink-float tank to maintain the specific gravity of the saltwater in the sink-float tank within a threshold range, wherein the saltwater removed from the lighter plastic pieces in the dewatering auger assembly is returned to the sink-float tank, and wherein the water separated from the black mass material in the filter press is used in at least one of the at least one of the deluge shredder assembly and the wet scrubber.

11. An apparatus for shredding and recycling a plurality of electronic devices containing lithium batteries, comprising:
an elongated platform comprising a top surface, a bottom surface, a pair of longitudinal sides defining a length of the elongated platform, and a pair of transverse sides extending between the longitudinal sides and defining a width of the elongated platform, wherein the pair of longitudinal sides and the pair of transverse sides define a perimeter of the elongated platform;
a deluge shredder assembly connected to the elongated platform, wherein the deluge shredder assembly receives the electronic devices and comminutes the electronic devices with a flow of water into solid fragments and a black mass slurry with black mass material mixed with the water;
a vibratory pan assembly positioned below the deluge shredder assembly, wherein the vibratory pan assembly receives the solid fragments and the black mass slurry, and wherein the vibratory pan assembly is comprised of a perforated plate and a ledge at a distal end;
a black mass tank connected to the elongated platform and positioned below the vibratory pan assembly, wherein the black mass slurry passes through the perforated plate into the black mass tank, and wherein the black mass material settles at a bottom of the black mass tank;
a pump operatively connected to the bottom of the black mass tank;
a filter press, wherein the pump pushes the black mass material and water from the bottom of the black mass tank through the filter press, and wherein the filter press separates the black mass material from the water;
a sink-float tank directly fastened to the elongated platform and positioned adjacent to the vibratory pan assembly, wherein the sink-float tank comprises a weir and a discharge end spaced away from the weir, wherein the ledge at the distal end of the vibratory pan assembly extends into an interior of the sink-float tank, wherein the solid fragments pass from the distal end of the vibratory pan assembly into the sink-float tank, wherein the sink-float tank contains saltwater with a specific gravity within a threshold range allowing lighter plastic pieces in the solid fragments to float at a waterline for the saltwater and heavier pieces in the solid fragments to sink to a bottom of the sink-float tank, wherein the waterline is proximate to a crest of the weir, and wherein the sink-float tank comprises at least one drive for moving the plastic pieces over the crest of the weir with a nappe of the saltwater and for extracting the heavier pieces from the bottom of the sink-float tank at the discharge end;
a dewatering auger assembly in fluid communication with the sink-float tank, wherein the dewatering auger assembly receives in a lower end the lighter plastic pieces and the nappe of saltwater from the weir, and wherein the dewatering auger assembly removes the saltwater at the lower end and expels the plastic pieces at an upper end; and
a takeaway conveyor assembly positioned adjacent to the sink-float tank, wherein the takeaway conveyor assembly has an extended position for an operating configuration of the apparatus, wherein the takeaway conveyor assembly has a retracted position for a shipping configuration of the apparatus, wherein the takeaway conveyor assembly is entirely situated within the perimeter of the elongated platform in the retracted position, wherein a takeaway tail at a proximal end of the takeaway conveyor assembly is positioned below the discharge end of the sink-float tank and receives the heavier pieces, wherein the heavier pieces are discharged from a takeaway head at a distal end of the takeaway conveyor assembly, and wherein the takeaway head extends beyond the perimeter of the elongated platform in the extended position.

12. The apparatus of claim 11 wherein the weir is located in a first end of the sink-float tank, wherein the discharge end is comprised of an inclined ramp at a second end opposite from the first end, wherein the sink-float tank further comprises a continuous loop drag chain assembly extending between the first end and the second end, wherein the inclined ramp extends from the bottom of the sink-float tank to a drop-off chute positioned at a height above the waterline, wherein the continuous loop drag chain assembly is comprised of a pair of chain-link loops on opposite sides of the sink-float tank, a plurality of paddles connected to and extending between the chain link loops, and a drive for rotating the drag chain assembly, wherein an upper horizontal section of the chain-link loops is proximate to the waterline, wherein a lower horizontal section of the chain-link loops is proximate to the bottom of the sink-float tank, wherein the paddles in the upper horizontal section push the lighter plastic pieces to the first end and over the crest of the weir with the nappe of the saltwater, and wherein the paddles in the lower horizontal section push the heavier pieces along the bottom of the sink-float tank and up the inclined ramp to the drop-off chute.

13. The apparatus of claim 11, wherein the length of the elongated platform is more than four times the width of the platform, wherein the dewatering auger assembly is comprised of a sump pump at the lower end, a discharge chute proximate to the upper end, and an inclined auger extending between the sump pump and the discharge chute, wherein the discharge chute extends beyond the perimeter of the elongated platform in the operating configuration of the apparatus, and wherein the discharge chute is situated entirely within the perimeter of the of the elongated platform in the shipping configuration of the apparatus.

14. The apparatus of claim 11, further comprising a shaker table frame with a bottom section mounted to the elongated platform on opposite sides of the black mass tank and a top section extending above and over the black mass tank, wherein the deluge shredder assembly and the vibratory pan assembly are mounted to the top section of the shaker table frame, wherein the black mass tank is mounted directly to the elongated platform within the bottom section of the shaker table frame, and wherein the sink-float tank, the dewatering auger assembly, and the takeaway conveyor assembly are mounted directly to the elongated platform separate from the shaker table.

15. The apparatus of claim 11, further comprising:
an infeed hopper for receiving the electronic devices, wherein the infeed hopper comprises an open topside, a tapered lower section, a door positioned in an aperture at a bottom of the tapered lower section, and an actuator operatively connected to the door, wherein the actuator adjusts door between a first position within the aperture and a second position within the aperture, wherein the first position opens a first portion of the aperture and has a first flow rate of the electronic devices, wherein the second position opens a second portion of the aperture and has a second flow rate of the electronic devices, and wherein the second portion of the aperture and the second flow rate are greater than first portion of the aperture and the first flow rate, respectively;
a lateral conveyor positioned below the aperture of the infeed hopper, wherein the lateral conveyor receives the flow of the electronic devices from the infeed hopper at a lateral tail and discharges the electronic devices at a lateral head; and
an inclined conveyor extending from a lower tail to an upper head, wherein the lower tail is positioned below the lateral head and is mounted directly to the elongated platform, and wherein the upper head reaches an opening of the deluge shredder assembly and is mounted to the top section of the shaker table frame.

16. A method for shredding and recycling a plurality of electronic devices containing lithium batteries, comprising the steps of:
providing a flow of the electronic devices to a deluge shredder assembly;
comminuting in the deluge shredder assembly the electronic devices with a flow of water, wherein the comminuted electronic devices are comprised of solid fragments and a black mass slurry with black mass material mixed with the water;
separating the black mass slurry from the solid fragments using a vibratory pan assembly, wherein the vibratory pan assembly comprises a perforated plate and a ledge at a distal end, wherein the black mass slurry passes through the perforated plate into a black mass tank, and wherein the solid fragments pass from the distal end of the vibratory pan assembly into a sink-float tank containing saltwater with a specific gravity allowing lighter plastic pieces in the solid fragments to float at a waterline for the saltwater and heavier pieces in the solid fragments to sink to a bottom of the sink-float tank;
pumping the black mass slurry from the black mass tank through a filter press, wherein the filter press separates the black mass material from the water;
rotating a continuous loop drag chain assembly within the sink-float tank, wherein the sink-float tank comprises a weir at a first end and an inclined ramp at a second end opposite from the first end, wherein the waterline is proximate to a crest of the weir, wherein the inclined ramp extends from the bottom of the sink-float tank to a drop-off chute positioned at a height above the waterline, wherein the continuous loop drag chain assembly is comprised of a pair of chain-link loops on opposite sides of the sink-float tank, a plurality of paddles connected to and extending between the chain link loops, wherein an upper horizontal section of the chain-link loops is proximate to the waterline, wherein a lower horizontal section of the chain-link loops is proximate to the bottom of the sink-float tank, wherein the paddles in the upper horizontal section push the lighter plastic pieces to the first end and over the crest of the weir with a nappe of the saltwater when the continuous loop drag chain is rotating, and wherein the paddles in the lower horizontal section simultaneously push the heavier pieces along the bottom of the sink-float tank and up the inclined ramp to the drop-off chute when the continuous loop drag chain is rotating;
removing the saltwater from the lighter plastic pieces that had been pushed over the crest of the weir; and
discharging the heavier pieces from the drop-off chute.

17. The method of claim 16, further comprising the steps of:
providing an elongated platform comprising a top surface, a bottom surface, a pair of longitudinal sides, and a pair of transverse sides extending between the longitudinal sides, wherein the pair of longitudinal sides and the pair of transverse sides define a perimeter of the elongated platform;
mounting to the elongated platform within the perimeter the deluge shredder assembly, the vibratory pan assembly, the black mass tank, the sink-float tank;
mounting a takeaway conveyor assembly to the elongated platform adjacent to the sink-float tank, wherein a takeaway tail is positioned below the drop-off chute, and wherein a takeaway head is positioned away from the sink-float tank;
extending the takeaway conveyor assembly to an operating configuration, wherein the takeaway head extends beyond the perimeter of the elongated platform in the operating configuration; and
retracting the takeaway conveyor assembly to a shipping configuration, wherein the takeaway conveyor assembly is situated entirely within the perimeter of the elongated platform in the shipping configuration.

18. The method of claim 17, further comprising the steps of:
mounting a shaker table frame directly to the elongated platform within the perimeter, wherein the shaker table frame comprises a bottom section mounted to the elongated platform on opposite sides of the black mass tank and a top section extending above and over the black mass tank;
mounting the deluge shredder assembly and the vibratory pan assembly to the top section of the shaker table frame;
mounting the black mass tank directly to the frame within the bottom section of the shaker table frame; and
mounting the sink-float tank and the takeaway conveyor assembly directly to the elongated platform separate from the shaker table.

19. The method of claim 18, further comprising the steps of:
receiving the electronic devices in an infeed hopper;
moving the electronic devices from the infeed hopper to the deluge shredder assembly with a lateral conveyor and an inclined conveyor comprising a lower tail and an upper head;
mounting directly to the elongated platform within the perimeter the infeed hopper and the lateral conveyor;
mounting the lower tail of the inclined conveyor directly to the elongated platform; and
mounting the upper tail of the inclined conveyor to the top section of the shaker table frame.

20. The method of claim 16, further comprising the steps of:
providing a plurality of exhaust ducts, a wet scrubber, and an exhaust fan;
drawing with the exhaust fan an airflow from the exhaust ducts to the deluge shredder assembly and the sink-float tank at an upstream end to the wet scrubber at a downstream end;
removing entrained solids and condensate from the airflow in the wet scrubber; and
draining the entrained solids and condensate from the wet scrubber to the black mass tank.
